(19) United States
(12) Patent Application Publication
(10) Pub. No.: US 2006/0190319 A1
(43) Pub. Date: Aug. 24, 2006

(54) Realtime, structured, paperless research methodology for focus groups

(75) Inventor: Kaivalya L. Hanswadkar, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/062,027

(22) Filed: Feb. 18, 2005

(51) Int. Cl. G07G 1/00

(52) U.S. Cl. 705/10

(57) ABSTRACT

A methodology for realtime paperless research in focus group generating valid actionable feedback and data before, during or within a very short period of the session. The methodology includes collection, processing mapping, analyzing and recognizing patterns of data points using multiple iterations in order to generate and output the valid actionable research data. The actionable data can be defined by converging data patterns and composite scores derived during the session. The methodology provides software tools and electronic survey mechanisms such that sufficient time can be expended to discuss the results between iterations. These interactive and focused discussions drive immediate changes in the survey such that the survey is ready in a short period of time for the next iteration. Converging patterns are generated by overlaying data from each iteration on top of the old data. Subcategories under parent categories are similarly processed during the group session.

### TECHNICAL FIELD

This invention is related to data processing, and more specifically, to data processing during group sessions for interactive feedback.

### BACKGROUND OF THE INVENTION

In large organizations, focus groups are organized with customers, partners, MVPs (Most Valued Partners), etc., on various products that are in development to understand market opportunities, feature priorities, customer pain points, and typical tasks they do, for example. These may not be just absolute opportunities in the market but also relative opportunities compared to the competition. These focus groups are conducted in various forms by product planning teams, usability teams, market research folks and multiple other disciplines. One way of conducting the focus group is to present categories of data for feedback and, elicit priorities and audience perception based on that data. For the purpose of this description, such focus groups where the audience is surveyed to generate quantitative data are designated objective focus groups. Another type of group is a subjective focus group where there is presented a topic for discussion and the notes generated are mostly qualitative.

At many meetings/conferences/focus groups, for example, both of these methods can be practiced. However, such traditional focus-group facilitations are time consuming and do not generate actionable research data during the session or promptly thereafter simply because it involves many manual tasks, presentations, paper surveys and sticky note type of exercises. The feedback that is collected is a combination of objective/quantitative and subjective, and there is very little correlation established during the focus group session. Typically these correlation results come out a few days later. Even when conducting quantitative surveys the feedback mapping and pattern recognition can take an extended period of time. This is because it can take an inordinate amount of analysis to show converging data patterns that are generated during the focus group session.

Moreover, multiple data elicitation iterations and analyses with the same audience are virtually impossible as mapping, analyzing, prioritizing the data takes more time than is allotted for the focus group session. Affinity diagramming methods exist where the collective feedback is mapped on a flip chart and data is clustered that way. The problem is performing the data collection, gathering the feedback, analyzing the data, and then performing affinity diagramming to present the data back to the focus group for interactive post mortem discussion, in a limited time. Repeating the same process can be even more problematic.

Consequently, the analysis cannot be validated with the same group during the corresponding session. Given that it is virtually impossible to perform all of these activities using existing methodologies with the same focus group in limited time, there exists a substantial unmet need for such an architecture.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a focus group methodology for realtime interactive feedback. The methodology includes mapping and recognizing patterns of data points, using multiple iterations during the session to generate valid actionable research data. The actionable data is defined by converging data patterns and composite scores derived during the focus group session.

The methodology provides software tools and electronic survey mechanisms such that sufficient time is spent to discuss the results between iterations. These interactive and focused discussions drive changes in the survey immediately and the survey is ready in a very short period of time (e.g., minutes) for the next iteration. Converging patterns are generated by comparing data from each iteration and sometimes by overlaying on the old data. Subcategories under the parent categories also go through the same process. These subcategories are either brainstormed or are typically predetermined.

The methodology supports identification of the “what” aspect of participant feedback, for example what categories of interests and features thereof that are deemed important by the session participants. The methodology also supports a “deep dive” subjective survey which helps understand the “why” aspect of why participants made particular choices, and facilitates correlation of data between the objective and subjective surveys.

In support thereof, there is provided a system that facilitates realtime iterative feedback mapping and pattern recognition for participants of a focus group in accordance with the subject invention. The system is employed as a tool for focus groups or working groups whose participants provide information and are fed back interim results for iterative processing with a realtime analysis component to ultimately produce actionable research results.

With respect to mapping of the scores/feedback provided by the audience, feedback mapping can be done on one or more metrics (e.g., typically two). These metrics, include, but are not limited to, Importance, Satisfaction, Complexity, and Completeness, for example. Determining this composite score with various dimensions and metrics is a key aspect of the methodology. The scores are what get processed and analyzed to determine feedback maps, clusters, and converging data patterns. Scores are presented by plotting various charts, scatter plots and maps typically representing 2×2 matrices of metrics as done in few market opportunity analyses, e.g., Importance vs. Satisfaction, Importance vs. complexity, and so on.

The focus group can then get multiple perspectives (this is very critical) on the categories and metrics surveyed, which promotes deep and interactive discussion. Again, the metrics like importance, completeness of features can be identified as a part of the focused interactive discussion, but most typically, are predetermined goals for the focus group. The composite score is not just calculated using medians and averages, as determined traditionally, but also takes into consideration the standard deviation/variance, and maps the categories accordingly to generate discussions. The composite scores at the subcategory level are compiled, aggregated, and correlated to the parent category scores to find very informative insights.

In addition to the feedback processing, this research methodology is unique because it includes the capability to capture the interactive discussion as survey categories in a paperless electronic format (e.g., XML forms) in realtime. The survey forms are uploaded to the virtual shared workspace for immediate feedback. This facilitates multiple iterations to be done quickly and in a structured manner (e.g., XML schema of the form is fixed) so that the results can be compared/overlaid.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates realtime iterative feedback mapping for participants of a focus group in accordance with the subject invention.

FIG. 2 illustrates a high-level methodology of realtime iterative feedback mapping for participants of a focus group in accordance with the subject invention.

FIG. 3 illustrates a system that facilitates realtime iterative feedback mapping for participants of a focus group in accordance with the subject invention.

FIG. 4 illustrates a more detailed methodology of realtime interactive focus group data processing in accordance with the invention.

FIG. 5 illustrates an exemplary collaboration site graphical user interface (GUI) in accordance with the invention.

FIG. 6 illustrates a screenshot of a sample GUI template form for indicating granular feature ranking in accordance with the invention.

FIG. 7 illustrates a screenshot of a sample analysis chart that is employed to present prioritized ideas in accordance with the invention.

FIG. 8 illustrates a screenshot of a sample scatter plot that is employed to present distributions of idea features in accordance with the invention.

FIG. 9 illustrates a screenshot of sample deep dive qualitative survey results in accordance with the invention.

FIG. 10 illustrates a block diagram of a computer operable to execute the disclosed architecture.

FIG. 11 illustrates a schematic block diagram of an exemplary computing environment in accordance with the subject invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

While certain ways of displaying information to users are shown and described with respect to certain figures, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

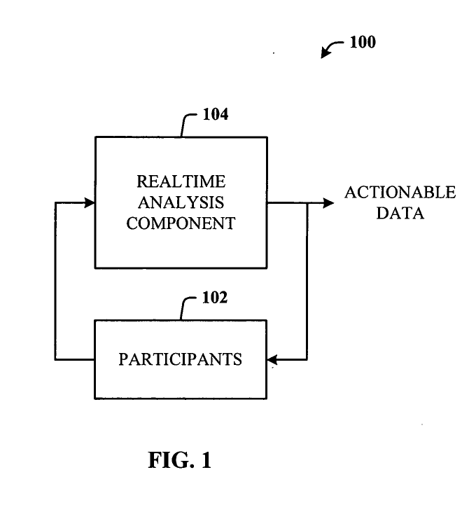

Referring initially to the drawings, FIG. 1 illustrates a system 100 that facilitates realtime structured paperless research for participants 102 of a focus group in accordance with the subject invention. The system 100 is employed as a tool for focus groups or working groups whose participants 102 provide information and are fed back interim results for iterative processing with a realtime analysis component 104 to ultimately produce actionable research results.

This new methodology along with the appropriate software productivity tools and an information technology infrastructure helps the focus group be much more efficient, paperless, and state-of-the-art in the quality of data collected, in a realtime and interactive fashion. The disclosed methodology can be employed to perform multiple iterations to generate converging data patterns and composite scores during the focus group. Software tools and electronic survey mechanisms facilitate participant interaction such that sufficient time is spent on discussing the results between iterations.

These interactive and focused discussions drive changes in surveys immediately, such that a survey can be ready in a very short period of time (e.g., minutes) for the next iteration. Converging patterns are generated by overlaying data from each iteration on top of the old data. Subcategories under the parent categories also go through the same process. These subcategories can be brainstormed or predetermined.

The disclosed architecture facilitates the identification of metrics for the categories and subcategories under survey/study and designing survey forms on-the-fly accordingly. Composite scores are computed based on medians/averages and standard deviations on values allocated by the focus group on various metrics. Matrices and maps of category and subcategory scores can be created. Category clusters and maps that are generated are presented for interactive post-mortem discussion. Multiple iterations of the exercise can be performed to generate converging patterns for further drill down. The category clusters are utilized to determine the subcategories within the categories for further feedback. “Deep dive” surveys are generated on and conducted in parallel with the categories for later correlation to understand the “Why” aspect of the feedback. Individual subcategory scores are aggregated on various metrics and compared against the higher level categories to determine correlation data. The correlation data is then presented to the session participants for the overall output post-mortem review. All of the above can be performed progressively and interactively in front of the same focus group within a relatively short period of time (e.g., 2-3 hours).

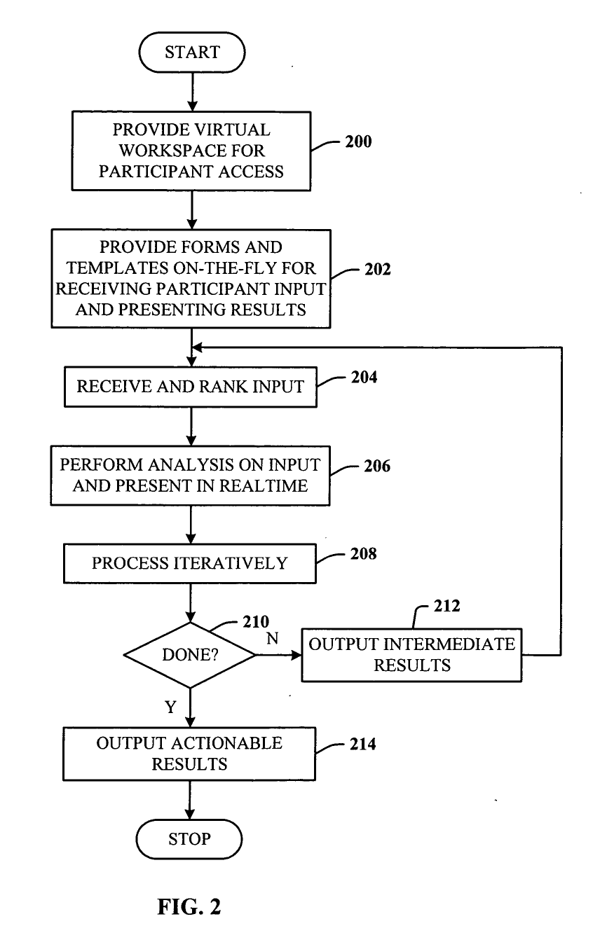

FIG. 2 illustrates a high-level methodology of realtime iterative feedback mapping and pattern recognition for participants of focus group in accordance with the subject invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 200, a virtual workspace is created for participant access. Creating a virtual focus group workspace prior to the meeting facilitates participant collaboration, conducting prioritization surveys, etc., during the session, or at anytime thereafter. At 202, tools can be provided that facilitate the generation of forms for various aspects of the focus group. Alternatively, or in combination with the tools, standardized forms can be provided for quick access and data entry on-the-fly for receiving participant input and presenting results. The electronic forms can be created on-the-fly based on the focus group ideas during the meeting or prior to the meeting, such that the form lists a number of high-level ideas/concepts.

At 204, once participant input is received, the input can be ranked or prioritized. For example, ideas and concepts can be ranked according to resource allocation exercises (e.g., the importance metric on categories/features that are to be prioritized can be determined using virtual dollar spending exercises). At 206, analysis is then performed to arrive at interim results which are then presented back to the participants in realtime. Processing the participant data includes graphing or mapping the data. In one implementation, this is accomplished using a 2×2 matrix/scatter plot of the data in two dimensions; however, many dimensions can be provided and analyzed. Dimensions for the mapping can be determined during the ranking process and mapped to the resource allocations. For example, the two dimensions could be, “How many dollars would you spend on an idea?” and “In what timeframe do expect to spend the money?”

At 208, the interim results can further be discussed and processed iteratively to arrive at new interim results. The processed data, in the form of the mapping, is shown back to the same participants in substantially realtime, given that the analysis processing can take only a few moments. The participants can then provide subjective feedback on the ranking. At 210, a check is made to determine if the iterative process is finished. If no, intermediate results are output, at 212, and progress is back to 204 for further review. Performing ranking and prioritization iteratively and then mapping the results, supports the generation of clusters of ideas and concepts which define converging patterns of data. Alternatively, if the iterative process is complete, flow is to 214 where the final actionable results are output and presented to the participants.

More granular features/ideas within those high-level concepts and ideas can also be brainstormed, and the same iterative process exercised during the session. This need not be brainstormed by the same focus group; however, it can be. For example, ten high-level concepts are brainstormed and prioritized in a first phase. Each of those ten concepts includes five granular features after a second round of brainstorming. This exercise of ranking and mapping is repeated with these feature ideas, as well. Correlation is computed once all the fifty feature concepts have been prioritized and mapped. The feature cumulative scores (e.g., in the above case, Score=Average Dollars Spent/Average Timeframe) will be correlated with the high-level parent concept scores to generate definitive and actionable data.

Practicing the method as stated above helps to identify the “What” aspect of the feedback, for example, what the composite scores are for the categories. The methodology also supports a “deep dive” subjective survey which helps understanding the “Why” aspect. The disclosed methodology facilitates administration of the subjective survey, followed by the objective survey. The methodology also provides the correlation of data between the objective and subjective surveys.

With respect to mapping of the scores/feedback provided by the participants, feedback mapping can be performed on one or more metrics (e.g., typically two). These metrics, include, but are not limited to, Importance, Satisfaction, Complexity, and Completeness, for example. The scores are what get plotted to determine feedback maps, clusters, and converging data patterns. Scores are presented by plotting various charts, scatter plots and maps typically representing 2×2 matrices of metrics, e.g., Importance vs. Satisfaction, Importance vs. complexity, and so on.

The focus group can then get multiple perspectives on the categories surveyed, which promotes deep and interactive discussion. Again, the metrics can be identified as a part of the focused interactive discussion, but most typically, are predetermined goals for the focus group. The composite score is not just calculated using medians and averages, as determined traditionally, but also takes into consideration the standard deviation/variance, and maps the categories accordingly to generate discussions. The composite scores at the subcategory level are compiled, aggregated, and correlated to the parent category scores to find very informative insights.

This method involves technology to support focus groups and for generating normalized data. In one implementation the number of participants is limited to a minimum of twenty-five participants.

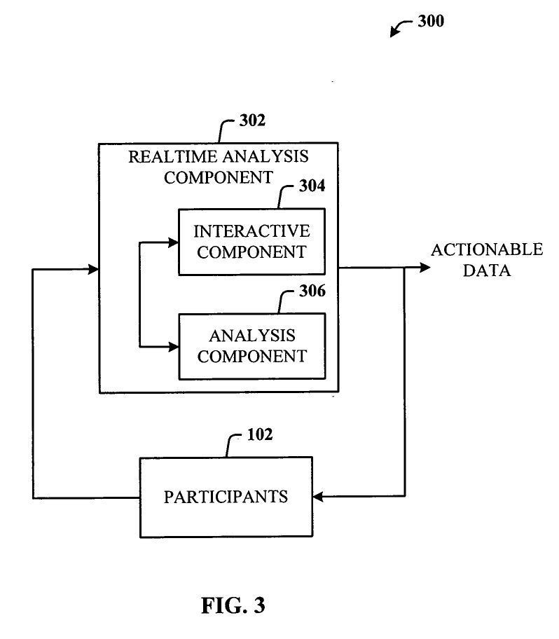

Referring now to FIG. 3, there is illustrated a system 300 that facilitates realtime iterative feedback mapping and pattern recognition for participants 102 of a focus group in accordance with the subject invention. In this implementation, a realtime analysis component 302 (similar to the realtime analysis component 104 of FIG. 1) includes an interactive component 304 that facilitates participant interaction locally, remotely or both. An analysis component 306 provides analysis and computational capabilities, and interfaces to the interactive component 304 such that participants 102, whether local or remote, can login and interact with a website in order to participate in the focus group session. It is to be appreciated that the website can be any type of controlled site such that only authorized users are allowed to participate. This application is more suitable for corporate environments and its customers, for example. The website can be an intranet such that corporate entities can login and participate virtually, if desired. In another implementation, the website is accessible by corporate, as well as externally authorized participants 102.

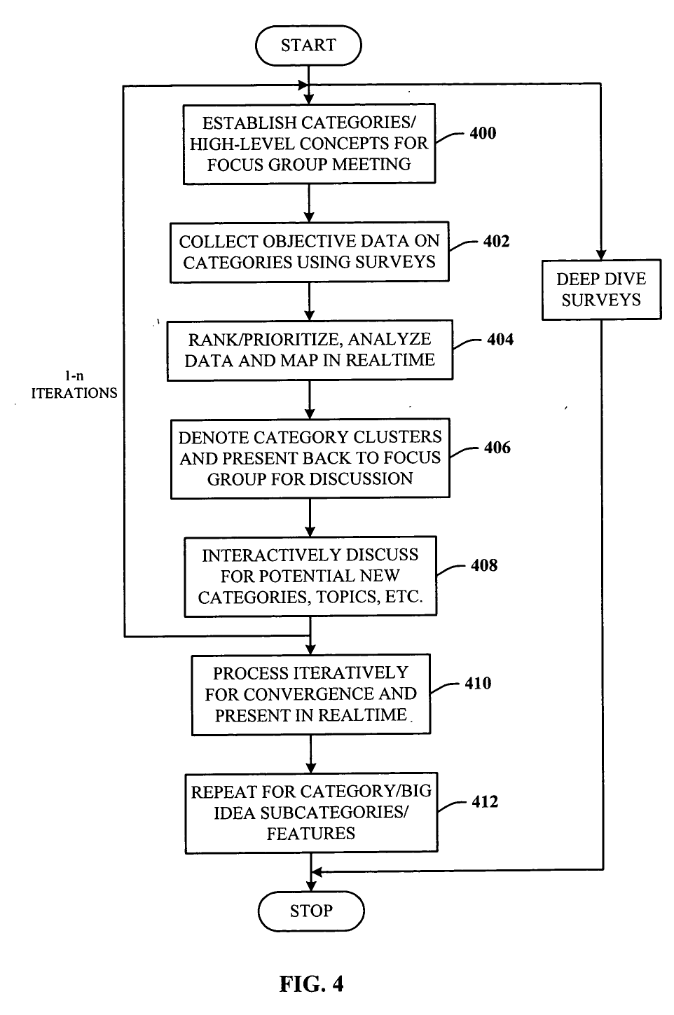

FIG. 4 illustrates a more detailed methodology of realtime interactive focus group data processing in accordance with the invention. At 400, high-level categories are established for the focus group meeting (or session). The methodology has at least two parallel operations being performed; the “What” aspect on the leftmost path where the high-level categories are surveyed to objectively understand why a participant made the choices they did, and the “Why” aspect, which is the rightmost path where the participants indicate what is important to them. The rightmost path indicates that in-depth (or “deep dive”) surveys are performed for each category in the leftmost path.

At 402, objective data is collected from the participants on the various categories using the surveys. At 404, the data is ranked/prioritized, analyzed, and mapped in realtime. At 406, clusters of data points are denoted as categories, and presented to the focus group participants for further discussion. The clustering/prioritization are not performed on subjective data but on the scores generated from metrics established for the exercise as a higher level goal. The focus group provides feedback accordingly by individual manipulation of the metrics. The data collected is collated to calculate the averages and variations on each of these metrics that determine the score on each category. These scores on each category make the process objective and quantitative.

At 408, the mappings are used for interactive discussion to determine if new categories and/or topics, for example, can be added. The discussion is based on various metrics on the categories that are mapped and presented. Metrics with high variance and high average are most typically opened for discussion to triage, and identify the appropriate clusters. If there are any additional categories that need to be evaluated in the second iteration, or some categories removed from consideration, this is performed substantially immediately (in realtime) such that the survey mechanism can re-administer the next iteration. The mappings can be, for example, a 2×2 matrix of various metrics that are determined early on for evaluating the categories, for example, Importance of that category versus Cost needed to implement the category, and so on. Multiples of these maps generate a rich interactive discussion with the focus group participants.

At 410, after multiple iterations, converging patterns evolve and are presented back to the focus group participants, substantially immediately. These individual patterns are overlaid on one another to identify the convergence of data collected. This process confirms and validates in real time that most people gravitate toward a fixed cluster of categories. At 412, subcategories within each category are collectively evaluated in the same manner as for the categories. Once the cluster of categories is identified, each category is fleshed out with the intended subcategories to get further deep and rich customer feedback. The scores on subcategories and the clusters generated from the final iteration which give the converging patterns, are aggregated to compare against the higher level category scores and clusters.

These ideas/concepts can be any topic, e.g., Features (for a new product), Learning (styles for participants), Market Segments, Personas, Tasks, Pain points that customers face, and so on. If the idea prioritization is performed remotely in a virtual environment, and if there is additional material to describe the idea, then each idea can be linked to that material. This method can be practiced on campus with the users or in a live meeting environment with remote users, as well.

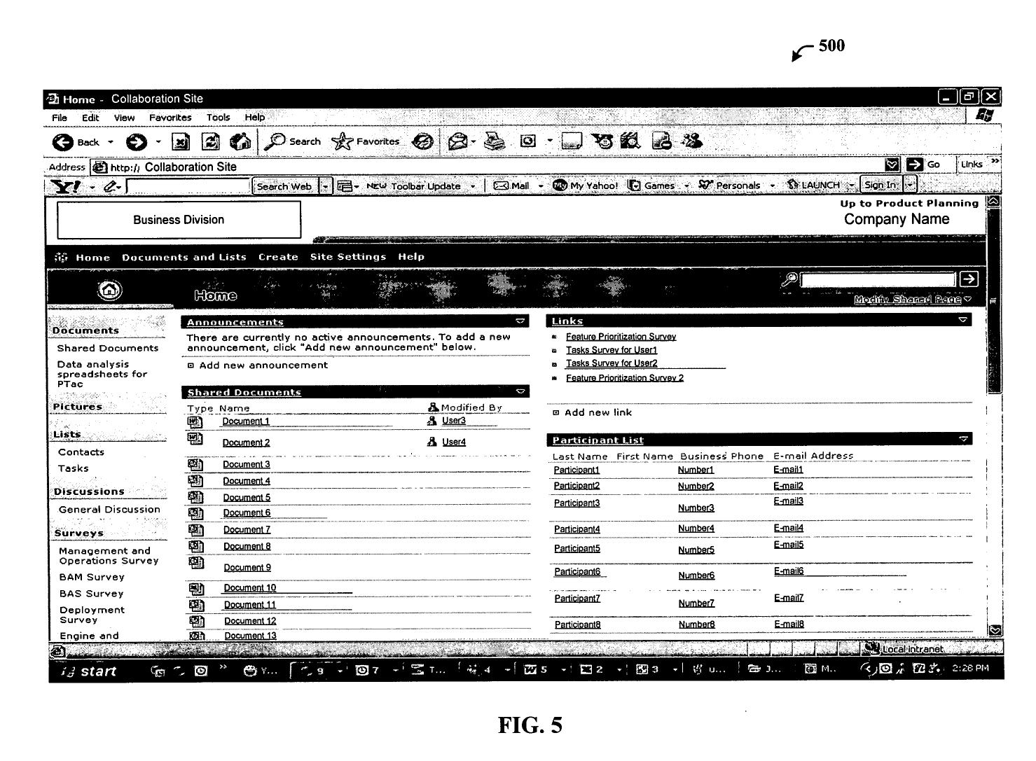

FIG. 5 illustrates an exemplary collaboration site graphical user interface (GUI) screenshot 500 in accordance with the invention. Any conventional collaboration software or mechanism can be employed to facilitate the subject invention. For example, in one implementation, a SHAREPOINT-type product, by Microsoft Corporation, is employed. The screenshot 500 shows a web page which presents to authorized users (or participants) information related to Documents, Pictures, Lists, Discussions, Surveys, Announcements, Shared Documents, Links, and a Participant List. The Surveys can be hyperlinked for accessing by participants in order to complete the survey, and also to view the survey results.

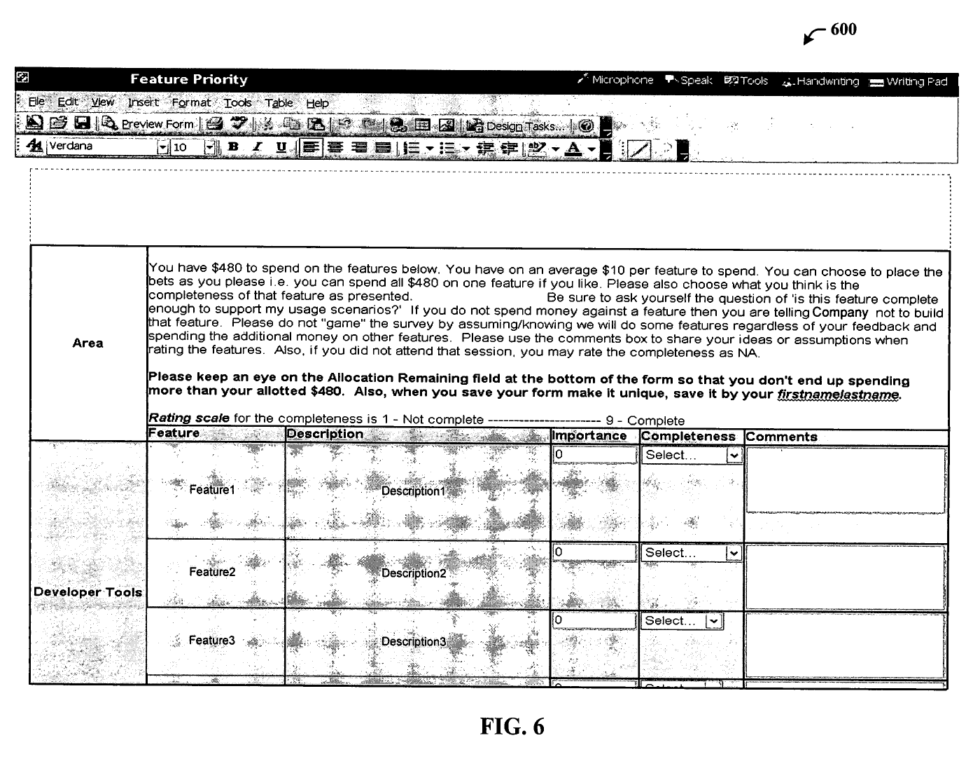

FIG. 6 illustrates a screenshot 600 of a sample GUI template form for indicating granular feature ranking in accordance with the invention. The form is used to capture requirements in structured electronic form as a focus group is in session. In this particular example, the form is used for feature prioritization using resource allocation/betting in a subsequent exercise. Many types of forms can be employed to facilitate various aspects of the subject invention, including, but not limited to that which can be provided by an INFOPATH-type product, by Microsoft Corporation. Here, the form includes a table with column headings of Feature, Description, Importance, Completeness, and Comments, and instructions for a hypothetical resource allocation exercise for determining the importance of such features.

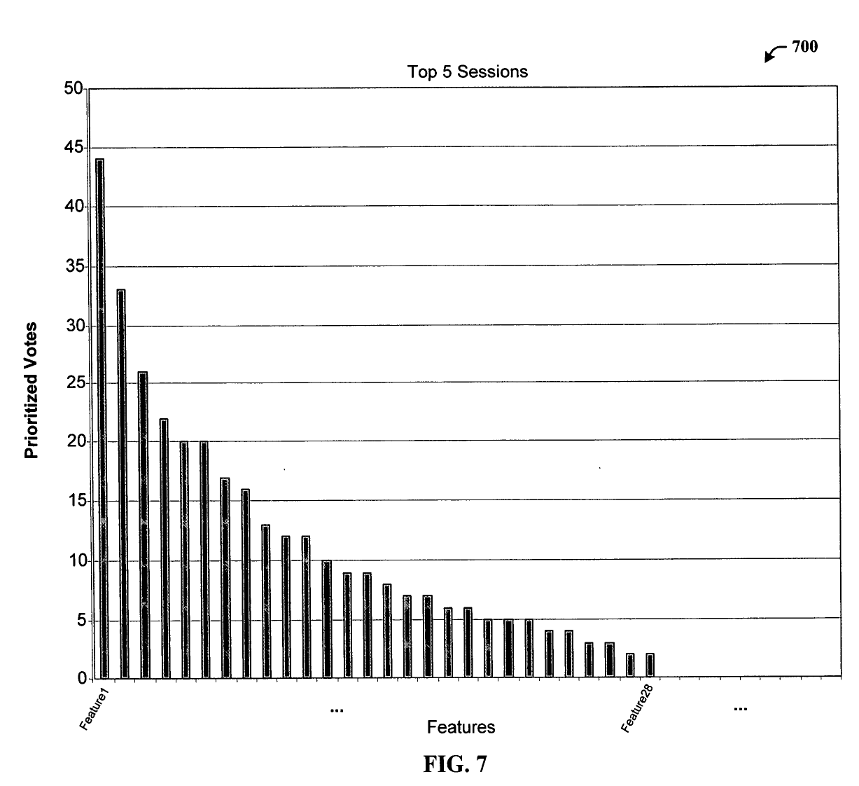

FIG. 7 illustrates a screenshot 700 of a sample analysis chart that is employed to present prioritized ideas in accordance with the invention. In this example, a bar chart is shown. Such analysis can be provided as tools in a number of different applications, for example, a spreadsheet application such as EXCEL by Microsoft Corporation. In this particular chart, the two dimensions are “Prioritized Votes” versus “Features” of a Top 5 Sessions.

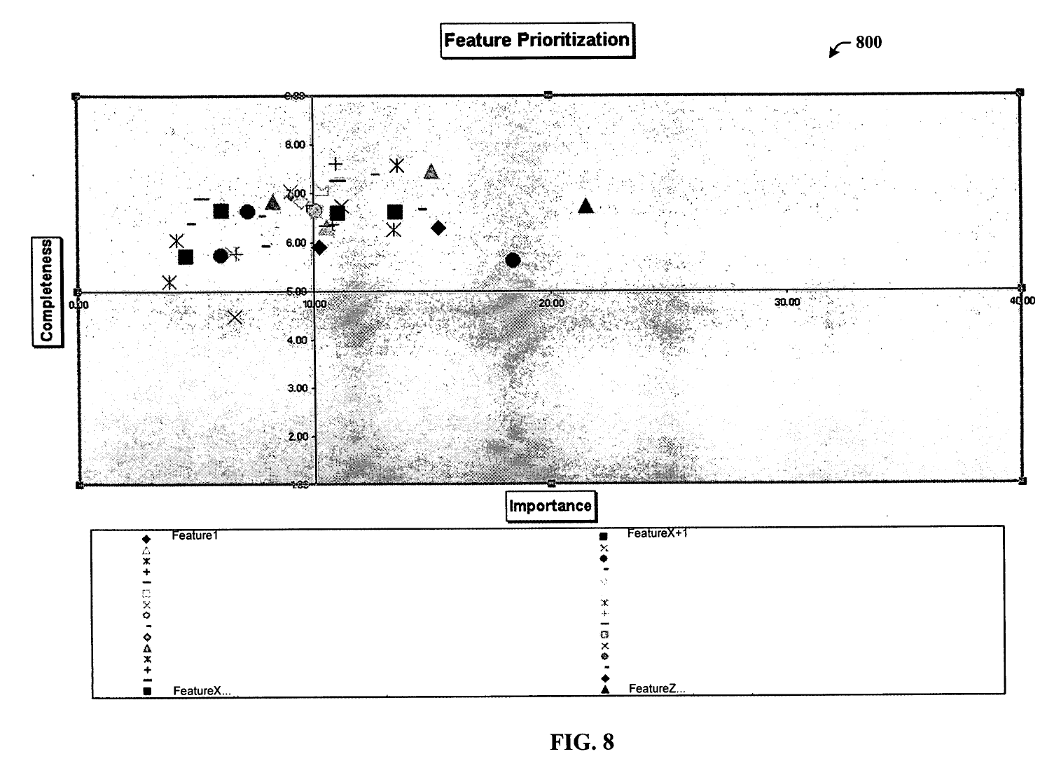

FIG. 8 illustrates a screenshot 800 of a sample feedback mapping scatter plot that is employed to present distributions of idea features in accordance with the invention. Complex feedback mapping can be provided based on a preconfigured spreadsheet template, for example, of FIG. 7. Here, a 2×2 matrix/scatter plot provides the mapping, which can be performed iteratively to find where data clusters, for example. The mapping is based on Completeness and Importance as plotting criteria, with a legend that describes each of the clustered indicia to the participating viewer.

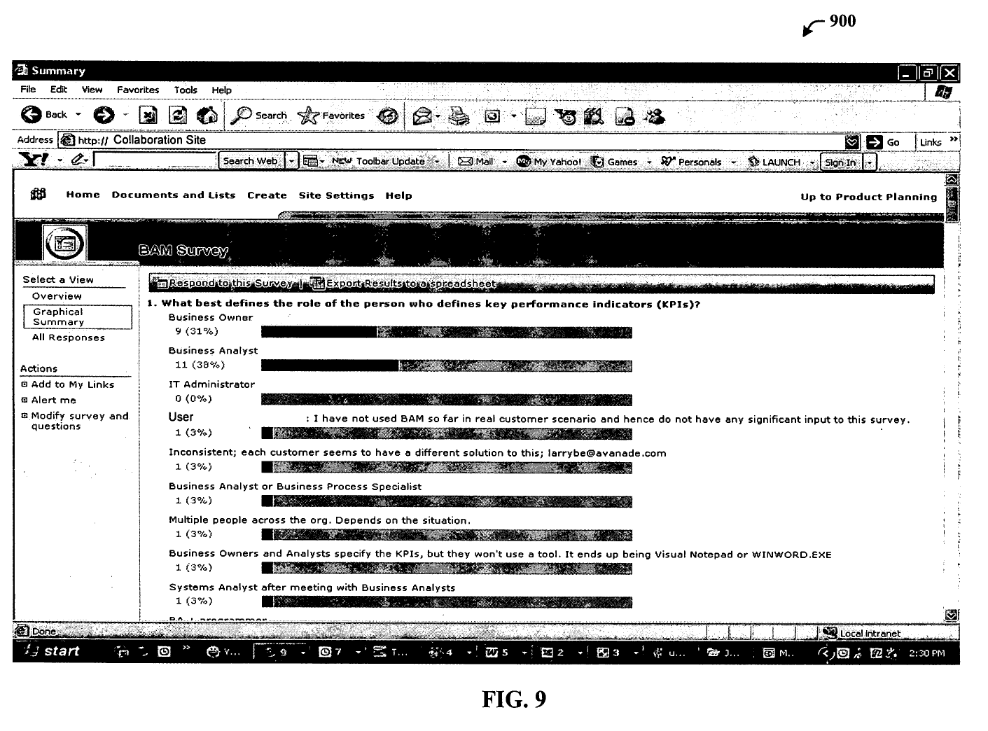

FIG. 9 illustrates a screenshot 900 of sample deep dive qualitative survey webpage showing survey results in accordance with the invention. Such a survey can be employed to better understand “why” a customer, whether an internal corporate or external purchasing customer, made the earlier prioritizations. The webpage provides a scrollable list of question results that can be reviewed by a session participant. In this presentation, the webpage illustrates that the results can be viewed graphically.

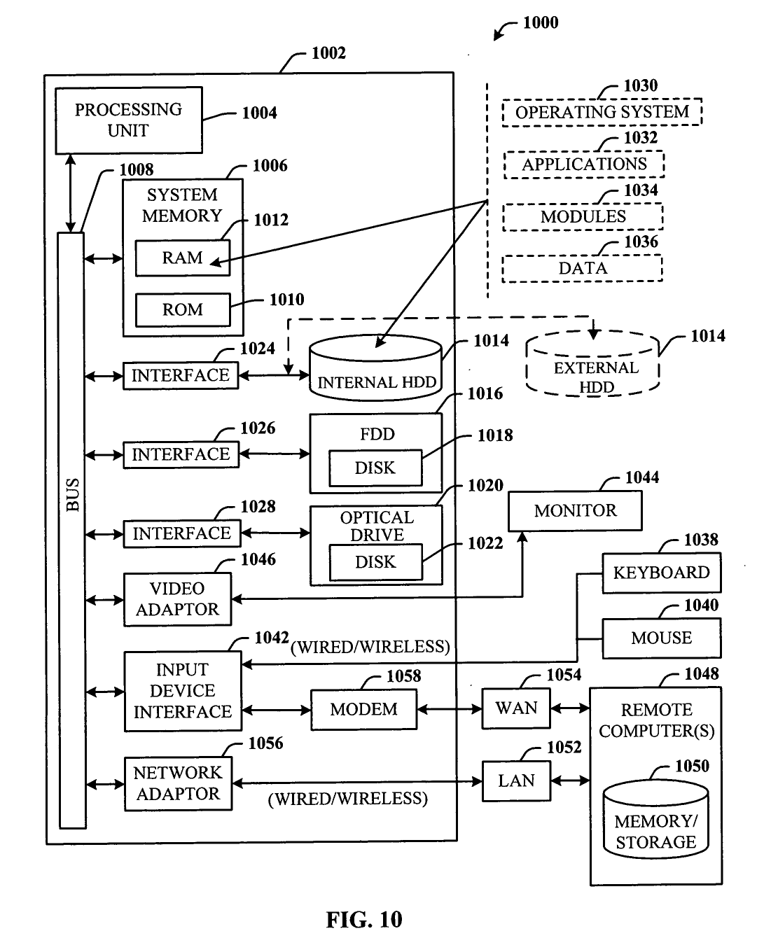

Referring now to FIG. 10, there is illustrated a block diagram of a computer operable to execute the disclosed architecture. In order to provide additional context for various aspects of the subject invention, FIG. 10 and the following discussion are intended to provide a brief, general description of a suitable computing environment 1000 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the invention includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

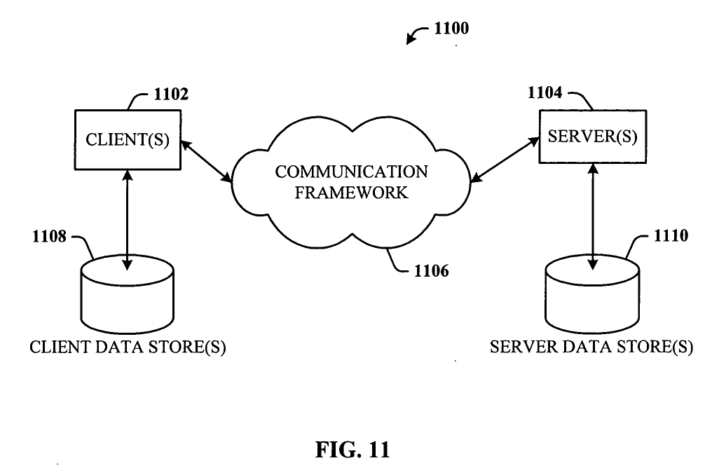

Referring now to FIG. 11, there is illustrated a schematic block diagram of an exemplary computing environment 1100 in accordance with the subject invention. The system 1100 includes one or more client(s) 1102. The client(s) 1102 can be hardware and/or software (e.g., threads, processes, computing devices). The client(s) 1102 can house cookie(s) and/or associated contextual information by employing the invention, for example.

The system 1100 also includes one or more server(s) 1104. The server(s) 1104 can also be hardware and/or software (e.g., threads, processes, computing devices). The servers 1104 can house threads to perform transformations by employing the invention, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates data processing for a group session, comprising:
an interactive component that receives input data from a session group which is derived iteratively during the session and presents actionable results generated from the input data; and
an analysis component that processes the input data during each iteration and generates the actionable results during the group session for perception by the session group.

2. The system of claim 1, wherein the analysis component facilitates realtime interactive feedback mapping and pattern recognition to generate the actionable results.

3. The system of claim 1, wherein the analysis component generates in substantially realtime a multi-dimensional matrix plot mapping of ranked and/or prioritized high-level categories determined by the session group.

4. The system of claim 3, wherein the mapping is presented back to the session group during the group session such that subjective feedback is obtained from the session group.

5. The system of claim 1, wherein the analysis component generates in substantially realtime a multi-dimensional matrix plot mapping of ranked and/or prioritized lower-level category features that are determined by the session group.

6. The system of claim 1, wherein the analysis component computes correlation information between categories and subcategories of the input data to obtain the actionable results.

7. The system of claim 1, wherein the interactive component includes a website that provides a virtual collaboration workspace that is accessible by participants of the session group to enter the input data and for perception of the actionable results.

8. The system of claim 1, wherein the interactive component includes a forms tool that facilitates the generation and use of forms in realtime and interaction with the forms such that session participants can enter survey information and perceive survey results.

9. A computer-readable medium having stored thereon computer-executable instructions for carrying out the system of claim 1.

10. A server that employs the system of claim 1.

11. A computer-readable medium having computer-executable instructions for performing a method of processing data of a group session, the method comprising:
providing a virtual interactive workspace via which one or more participants of the group session can enter and perceive data during the group session;
identifying metrics for categories and subcategories of interest via the workspace during the group session;
creating at least one of a matrix and a map of scores of the categories and subcategories of interest during the group session;
presenting the scores as clustered data to the one or more participants to receive revised input data during the group session; and
iteratively performing the acts of identifying, creating, and presenting, to generate actionable data during the session.

12. The method of claim 11, further comprising computing composite scores based on at least one of medians, averages, and standard deviations on values allocated by the session group on the metrics.

13. The method of claim 11, further comprising processing clusters of the categories of interest to determine the subcategories of interest.

14. The method of claim 11, wherein the act of performing is conducted until data converges.

15. The method of claim 11, further comprising generating and conducting at least one of an objective survey and a subjective survey during the session to obtain additional participant information.

16. The method of claim 11, further comprising the acts of:
correlating subcategory scores of one or more of the metrics with category scores to generate correlation data during the session; and
presenting the correlation data to the session group for review.

17. The method of claim 11, further comprising generating and conducting objective and subjective surveys during the group session to arrive at converging data.

18. A system that facilitates processing data of a focus group, comprising:
means for presenting initial data to one or more user participants of a session;
means for receiving feedback from the one or more participants during the session;
means for revising the initial data according to the feedback and presenting revised data during the session; and
means for iteratively performing the acts of presenting, receiving, and revising to generate actionable data during the session.

19. The system of claim 18, further comprising means for generating and conducting objective and subjective surveys during the group session to arrive at converging data.

20. The system of claim 18, further comprising means for computing multi-dimensional plots and maps for interactive discussion during the group session.
